(19) United States
(12) Patent Application Publication
(10) Pub. No.: US 2022/0413469 A1
(43) Pub. Date: Dec. 29, 2022

(54) DEVICE MANAGEMENT SYSTEM AND DEVICE MANAGEMENT DEVICE

(71) Applicant: Hitachi, Ltd., Tokyo (JP)

(72) Inventors: Mizuki SUGIYAMA, Tokyo (JP); Kagayaki ODA, Tokyo (JP); Shinichiro SAITO, Tokyo (JP); Daisuke ITO, Tokyo (JP)

(21) Appl. No.: 17/834,236

(22) Filed: Jun. 7, 2022

(30) Foreign Application Priority Data
Jun. 24, 2021 (JP) 2021-105237

(51) Int. Cl. G05B 19/418

(52) U.S. Cl. CPC G05B 19/4183

(57) ABSTRACT

A device management system comprises a data collection server and edge server including an adapter that transfers a device-related data set of an industrial device. Upon receipt of the device-related data set and when the data collection server is unable to specify a row that both adapter identification information of the device-related data set and device identification information match, in a devices list table and when the data collection server is able to specify a location name of a row that only the adapter identification information matches, in the devices list table, the data collection server is configured to generate/assign a new unique device identification ID based on the specified location name, the locations list table, and the devices list table. The data collection server associates the new unique device identification ID with the received device-related data set, and then stores the device-related data set in the data accumulation section.

### CROSS-REFERENCE TO RELATED APPLICATION

The present application claims priority from Japanese application JP2021-105237, filed on Jun. 24, 2021, the contents of which is hereby incorporated by reference into this application.

### BACKGROUND OF THE INVENTION

### 1. Field of the Invention

The present disclosure relates to a device management system and a device management device.

### 2. Description of the Related Art

A device management system collects data (information) that occurs on production sites such as factories and uses the collected data to manage, monitor, and analyze events occurring on the sites in real time. The device management system collects data (hereafter referred to as “device data”) related to a large number of industrial devices installed in a factory and assigns identification information (hereinafter referred to as “device identification information”) in order to identify which industrial device each of these pieces of device data belongs to. This allows the device management system to identify (specify) which industrial device the collected device data is related to.

Japanese Patent Application Laid-Open No. 2019-175068 discloses a device management system (hereinafter referred to as a “conventional system”) capable of individually managing device information on field devices The conventional system communicates with the field devices to acquire device data of the field devices, the device identification information, and additional information (the plant information that identifies the plant in which the field devices are installed) that the field devices assign to the device data.

The conventional system generates an identification key to identify device data using the device identification information and the additional information (plant information), associates the identification key with the device data, and stores the data in the storage unit.

In the conventional system, the device identification information should be unique for each plant where the field devices are installed. Therefore, in the conventional system, for example, the device identification information of the first field device installed in the first plant and the device identification information of the second field device installed in the second plant, which is a different plant from the first plant, may overlap.

In the conventional system, even in such a case, the plant information of the identification key of the first field device and the identification key of the second field device are different from each other, so the identification key of the first field device and the identification key of the second field device are different from each other.

Therefore, in the conventional system, a unique identification key (identification information) is assigned to device data collected from field devices installed in different plants for the entire system.

However, if the first field device installed in the first plant is moved to another plant for installation, the conventional system must change the plant information and generate a new identification key. Specifically, for example, if the first field device installed in the first plant is moved to the third plant, the conventional system must set (change) “1st plant” that is the additional information of the device identification information for the first field device to “3rd plant”. This additional information is set, for example, by the user operating the terminal that manages the field devices installed in the third plant. Therefore, the conventional system is likely to increase the workload of the user of the conventional system.

### SUMMARY OF THE INVENTION

The present disclosure has been made to address the aforementioned problem. That is, an object of the present disclosure is to provide a device management system and a device management device that can reduce a workload of a user when a location where a device is installed is changed.

The present disclosed device management system comprises:

a management server including a data accumulation section capable of storing data; and

an edge server that communicates with the management server each other and that includes an adapter configured to acquire data from one or more devices belonging to one location.

The edge server is configured to:

acquire device data that are data on the device and device identification information that the device associates with the device data; and

transfer, via the adapter that associates adapter identification information for identifying the adapter with the device data, a device-related data set including the device data, the device identification information, and
the adapter identification information that are associated with each other, to the management server;

the management server includes a storage section storing:

a plurality of pieces of first corresponding information in which a location name of the location to which the adapter belongs and location identification information for uniquely identifying the location are associated with each other; and

a plurality of pieces of second corresponding information in which the location name, the adapter identification information, the device identification information, device identification information-in-location for uniquely identifying the device belonging to the location within the location, and unique device identification information generated by combining the location identification information and the device identification information-in-location that are associated with each other; and

the management server is configured to:

upon receipt of the device-related data set,

combine, when the management server is unable to specify the second corresponding information that both of the adapter identification information and the device identification information of the received device-related data set matches, in the storage section and the management server is able to specify the second corresponding information that only the adapter identification matches, in the storage section, the location identification information of the first corresponding information corresponding to the location name of the specified second corresponding information and the device identification information-in-location newly generated to thereby generate a new unique device identification information;

associate the new unique device identification information with the received device-related data set; and

thereafter, store the device-related data set in the data accumulation section.

The present disclosed device management system comprises:

a management server including a data accumulation section capable of storing data; and

an edge server that communicates with the management server each other and that includes an adapter configured to acquire data from one or more devices belonging to one location.

The edge server is configured to:

acquire device data that are data on the device and device identification information that the device associates with the device data; and

transfer, via the adapter that associates adapter identification information for identifying the adapter with the device data, a device-related data set including:
the device data;
the device identification information; and
the adapter identification information, these being associated with each other,

to the management server;

the management server includes a storage section storing:
location information of the location to which the adapter belongs and device identification information-in-location for uniquely identifying the device belonging to the location within the location, these being associated with the adapter identification information; and
unique device identification information generated based on location identification information and the device identification information-in-location and associated with both the adapter identification information and the device identification information,

the management server is configured to:

upon receipt of the device-related data set,

generate, when the unique device identification information associated with both the adapter identification information and the device identification information of the received device-related data set is not stored in the storage section, a new unique device identification information

based on:
the location identification information associated with the adapter identification information of the received data-related data set, the location identification information being stored in the storage section; and
the device identification information-in-location stored in the storage section;

associate the new unique device identification information with the receive device-related data set; and

thereafter, store the device data-related data set in the storage section.

The disclosed device management device is configured to:

acquire device data that are data on a plurality of devices belonging to one location and device identification information that the device associates with the device data; and

receive data-related data set transferred from edge server including an adapter via the adapter that associate adapter identification information with the device data, the data-related data set including the device data, the device identification information, and the adapter identification information that are associated with each other.

The management device includes:

a data accumulation section capable of storing data; and

a storage section storing:

a plurality of pieces of first corresponding information in which a location name of the location to which the adapter belongs and location identification information for uniquely identifying the location are associated with each other; and

a plurality of pieces of second corresponding information in which the location name, the adapter identification information, the device identification information, device identification information-in-location for uniquely identifying the device belonging to the location within the location, and unique device identification information generated by combining the location identification information and the device identification information-in-location that are associated with each other; and

the management device is configured to:

upon receipt of the device-related data set,

combine, when the management device is unable to specify the second corresponding information that both of the adapter identification information and the device identification information of the received device-related data set matches, in the storage section and the management device is able to specify the second corresponding information that only the adapter identification matches, in the storage section, the location identification information of the first corresponding information corresponding to the location name of the specified second corresponding information and the device identification information-in-location newly generated to thereby generate a new unique device identification information;

associate the new unique device identification information with the received device-related data set; and

thereafter, store the device-related data set in the data accumulation section.

According to the present disclosure, the workload of the user can be reduced.

### BRIEF DESCRIPTION OF DRAWINGS

FIG. 1 shows a schematic diagram of an example configuration of a device management system according to an embodiment of the present disclosure.

FIG. 2 is a block diagram showing an example of an edge server hardware configuration.

FIG. 3 is a block diagram showing an example of the hardware configuration of a data collection server.

FIG. 4 is a functional block diagram of the edge server and the data collection server.

FIG. 5 illustrates an example of a locations list table.

FIG. 6 illustrates an example of a devices list table.

FIG. 7 is a sequence diagram to explain the process executed by the device information registration section.

FIG. 8 shows an example of a screen on a display.

FIG. 9 shows an example of a screen on the display.

FIG. 10 shows an example of a screen on the display.

FIG. 11 illustrates an example of the structure of a device-related data set collected by the device management system.

FIG. 12 is a sequence diagram illustrating the process after the point at which the adapter transfers the device-related data set to the data collection server.

FIG. 13 is a flowchart showing the routine performed by the storage section.

FIG. 14 is a flowchart showing the routine performed by the storage section.

FIG. 15 shows a schematic diagram of the device management system of FIG. 1 after changing installation states of an industrial device.

FIG. 16 shows a schematic diagram of the device management system of FIG. 1 after changing the installation states of the industrial device.

FIG. 17 shows a schematic diagram of the device management system of FIG. 1 after changing the installation states of the industrial device.

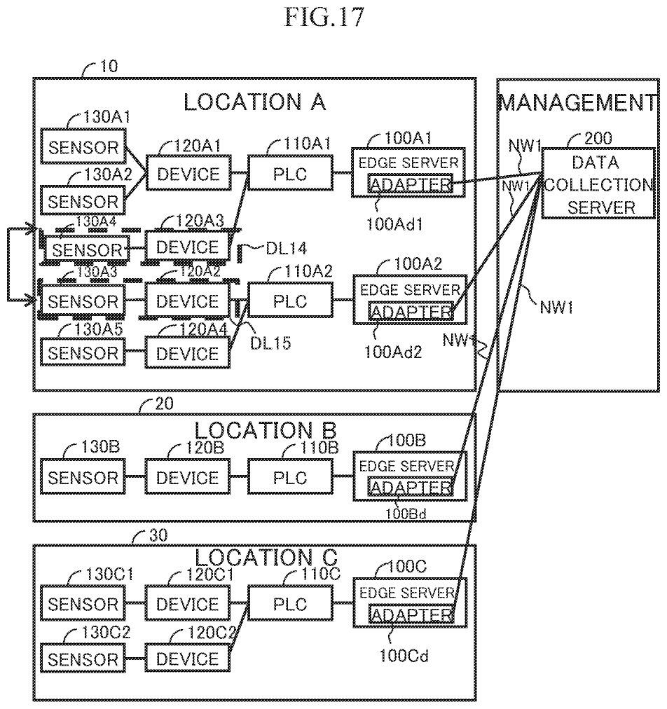

### DETAILED DESCRIPTION OF THE PREFERRED EMBODIMENTS

### Embodiment

<Configuration>

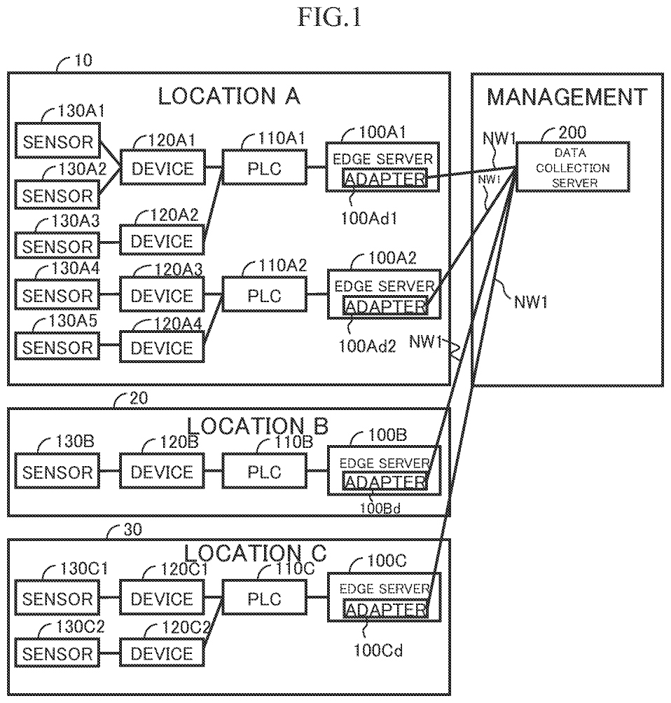

FIG. 1 is a schematic diagram for illustrating a device management system including a device management device (a data collection server 200) according to an embodiment of the present disclosure and locations A10 to C30 (e.g., factory, production site) including industrial devices 120A1 to 120C2 that are examples of devices managed by the device management system. As shown in FIG. 1, the device management system includes a plurality of edge servers 100A1 to 100C and the data collection server 200. It should be noted that the data collection server 200 may also be referred to as the “management server” for convenience. The edge servers 100A1 to 100C include adapters 100Ad1 to 100 Cd respectively. It should be noted that the edge servers 100A1 to 100C are referred to as “edge servers 100” when there is no need to distinguish between them. Each of the adapters 100Ad1 to 100Cd is referred to as an “adapter 100d” when there is no need to distinguish between them. The adapter 100d is installed on the edge server 100 and has the function of transferring data to the data collection server 200 via the network NW1.

The device management system collects information on one or more of the industrial devices 120A1 to 120C2 belonging to (that are present in) each of the location A10, the location B 20, and the location C 30 so as to manage, monitor, and analyze the collected information. That information is referred to as “device data”, hereinafter. It should be noted that each of the industrial devices 120A1 to 120C2 is referred to as the “industrial device 120” when there is no need to distinguish between them.

In the device management system, sequentially, device-related data sets including device data from multiple industrial devices 120 are sent to the data collection server 200 via the edge server 100 (the adapter 100d). The data collection server 200 successively receives the data from the edge server 100 (adapter 10) and stores/accumulates the device-related data sets.

The adapter 100Ad1 is connected to a PLC 110A1 in a location A 10. The PLC 110A1 is a programmable logic controller (Programmable Logic Controller) that controls the industrial devices 120A1, 120A2, and 120A2 that make up one production line and is connected to the industrial deices 120A1 and 120A2.

The industrial device 120A1 and the industrial device 120A2 are, for example, machine tools. The sensors 130A1 and 130A2 for detecting the device data on states of the industrial device 120A1 are installed on the industrial device 120A1. The sensor 130A3 for detecting the device data on states of the industrial device 120A2 is installed on the industrial device 120A2. For example, the sensor 130A1 is an ammeter that detects a current value at a predetermined position of the industrial device 120A1 as the device data. For example, the sensor 130A2 is a thermometer that detects a temperature at a predetermined position of the industrial device 120A1 as the device data. For example, the sensor 130A3 is an ammeter that detects a current value at a predetermined position of the industrial device 120A2 as the device data.

The adapter 100Ad2 is connected to a PLC 110A2 in the location A 10. The PLC 110A2 is a programmable logic controller that controls the industrial devices 120A3 and 120A4 that make up one production line and is connected to the industrial devices 120A3 and 120A4.

The industrial device 120A3 and the industrial device 120A4 are, for example, machine tools. The sensor 130A4 for detecting the device data on states of the industrial device 120A3 is installed on the industrial device 120A3. The sensor 130A5 for detecting the device data on states of the industrial device 120A4 is installed on the industrial device 120A4. For example, the sensor 130A4 is an ammeter that detects a current value at a predetermined position of the industrial device 120A3 as the device data. For example, the sensor 130A5 is an ammeter that detects a current value at a predetermined position of the industrial device 120A4 as the device data.

The adapter 100Bd is connected to a PLC 110B in the location B 20. The PLC 110B is a programmable logic controller that controls the industrial device 120B that make up one production line and is connected to the industrial deice 120B.

The industrial device 120B is for example, a machine tool. The sensor 130B for detecting the device data on states of the industrial device 120B is installed on the industrial device 120B. For example, the sensor 130B is an ammeter that detects a current value at a predetermined position of the industrial device 120B as the device data.

The adapter 100Cd is connected to a PLC 110C in the location C 30. The PLC 110C is a programmable logic controller that controls the industrial device 120C that makes up one production line in the location C 30 and is connected to the industrial devices 120C1 and 120C2. It should be noted that each of the PLC 110A1 to PLC110C is referred to as the “PLC110” when there is no need to distinguish between them, hereinafter.

For example, each of the industrial device 120C1 and the industrial device 10C2 is a machine tool. The sensor 130C1 for detecting the device data on states of the industrial device 120C1 is installed on the industrial device 120C1. The sensor 130C2 for detecting the device data on states of the industrial device 120C2 is installed on the industrial device 120C2. For example, the sensor 130C1 is an ammeter that detects a current value at a predetermined position of the industrial device 120C1 as the device data. For example, the sensor 130C2 is a thermometer that detects a temperature at a predetermined position of the industrial device 120C2 as the device data. It should be noted that each of the sensors 130A1 to 130C2 is referred to as the “sensor 130” when there is no need to distinguish between them.

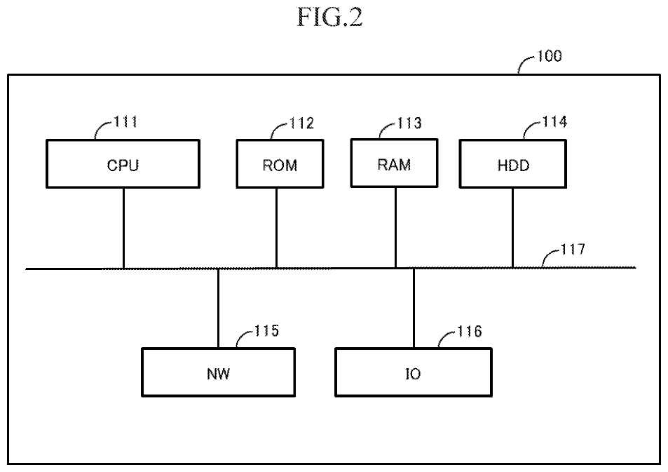

FIG. 2 is a schematic diagram showing an example of the hardware configuration of the edge server 100. As shown in FIG. 2, the edge server 100 includes a CPU 111, a ROM 112, a RAM 113, a non-volatile storage device capable of reading and writing data (HDD) 114, a network interface 115, and an input/output interface 116, etc. These are communicatively connected to each other via bus 117.

The CPU 111 loads various programs (not shown) stored in the ROM 112 into the RAM 113 and executes the programs loaded in the RAM 113, to thereby realize various functions. As described above, the various programs executed by the CPU is loaded into the RAM 114 and the data used when the CPU 111 executes the various programs are temporarily stored in the RAM 114. The ROM 112 is a non-volatile storage medium and stores the various programs. The network interface 115 is an interface for connecting the edge server 100 to the network NW1. The input/output interface 116 is an interface for which the edge saver 100 connects to a keyboard and a display.

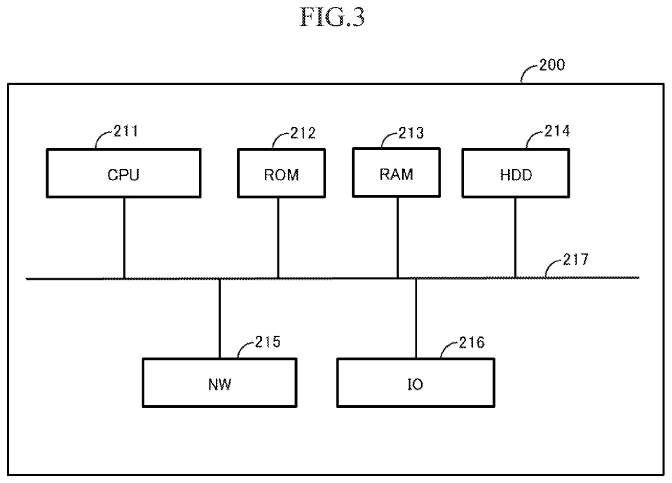

FIG. 3 is a schematic diagram showing an example of the hardware configuration of the data collection server 200. As shown in FIG. 3, the data collection server 200 includes a CPU211, a ROM 212, a RAM 213, a non-volatile storage device capable of reading and writing data (HDD) 214, a network interface 215, and an input/output interface 216, etc. These are communicably connected to each other via bus 217.

The CPU 211 loads various programs (not shown) stored in the ROM 212 into RAM 213 and executes the program to thereby realize various functions. The various programs to be executed by the CPU as describe above is loaded into the RAM 213 and data used when the CPU 211 executes the various programs is temporarily stored in the RAM 213. The ROM 212 is a non-volatile storage medium and stores various programs. The network interface 215 is an interface to allow the data collection server 200 to access the network NW1. The input/output interface 216 is an interface to allow the data collection server 200 to connect to a keyboard and a display.

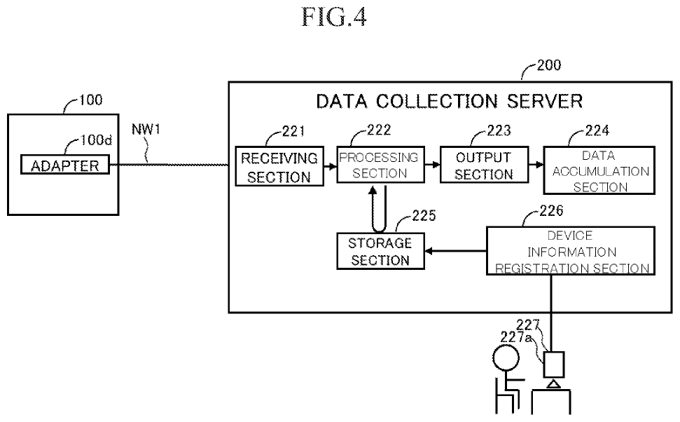

FIG. 4 is a functional block diagram of the edge server 100 and the data collection server 200. As shown in FIG. 4, the data collection server 200 includes, as functional blocks, a receiving section 221, a processing section 222, an output section 223, a data accumulation section 224, a storage section 225, and a device information registration section 226. These functional blocks can be realized by any combination of “hardware resources” and/or “software” provided by the data collection server 200.

For example, the receiving section 221 is composed of a network interface 215. For example, the processing section 222 and the output section 223 are composed of the various programs that are stored in the ROM 212 and/or the HDD 214 and are executed by the CPU 211. For example, the data accumulation section 224 is composed of the HDD 214. The storage section 225 is composed of the various programs that are stored in the ROM 212 and/or the HDD 214 and are executed by the CPU 211. The device information registration section 226 is composed of “the various programs that are stored in the ROM 212 and/or the HDD 214 and are executed by the CPU 211” and the input/output interface 216.

A terminal 227 that can be operated by the user is connected to the device information registration section 226. The terminal 227 includes a display 227a capable of displaying images (screens).

Although the details will be described later, the receiving section 221 receives the device-related data set including the device data transferred from the adapter 100d, and outputs the received device-related data set to the processing unit 222. The processing section 222 processes the device-related data set received from the receiving section 221 and outputs it to the output section 222. The output section 223 outputs the device-related data set processed by the processing section 222 to the data accumulation section 224. The data accumulation section 224 stores/accumulates the processed device-related data set received from the processing section 222 in the storing section 224.

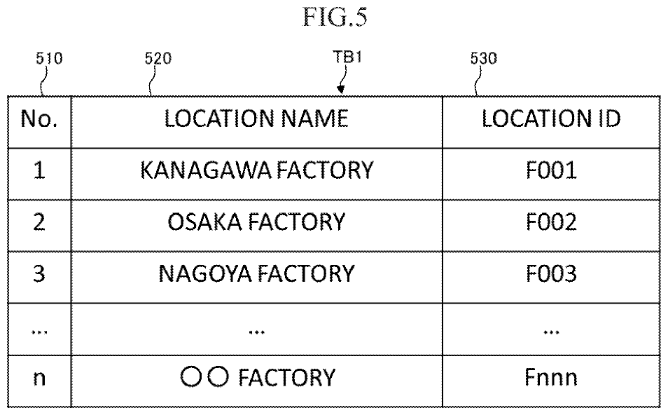

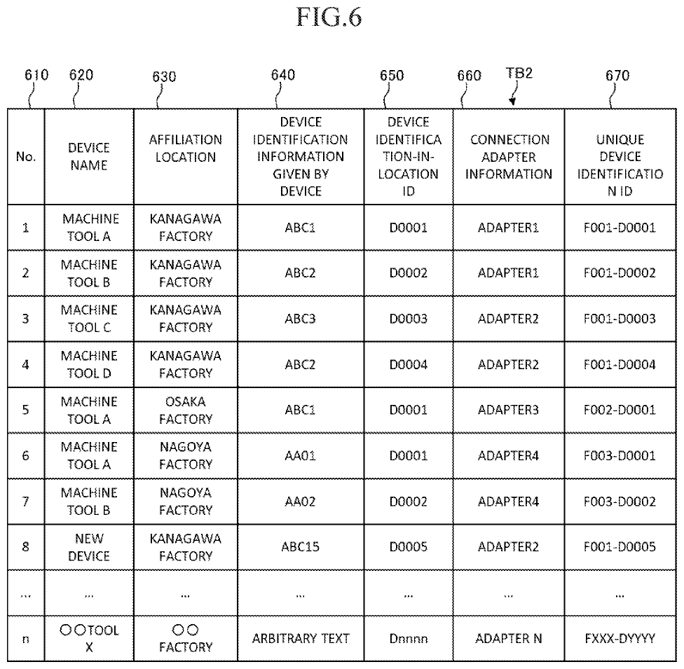

The storage section 225 stores a locations list table TB1 shown in FIG. 5 and a devices list table TB2 shown in FIG. 6, each of them being table information. It should be noted that the table information may be expressed in data structures other than these.

As shown in FIG. 5, the locations list table TB1 includes a row number 510, a location name 520, and a location ID 530. The information described below is registered in each of the row number 510, the location name 520, and the location ID 530 by a “location registration process” described in detail below.

The row number 510 is the number of the rows of the locations list table TB1, and the numbers are assigned from “1” in order from the top. The location name of the location to which the industrial device 120 belongs is registered (stored) in the location name 520. The identification information unique to each location (in this example, the location ID (for example, “FXXX”, “XXX” being numbers)) is registered (stored) in the location ID 530. It should be noted that the unique identification information to each location may also be referred to as “location identification information”, for convenience. In this specification, the identification information is not limited to a combination of alphabets and numbers, but can be any information to uniquely identify any object. As shown in FIG. 6, the devices list table TB2 includes a row number 610, a device name 620, an affiliation location 630, a device identification information 640 assigned by the device, a device identification-in-location ID 650, a connection adapter information 660, and a unique device identification ID 670.

The information described below is registered in each of the row number 610, the device name 620, the affiliation location 630, the device identification information 640 given by the industrial device 120, the device identification-in-location ID 650, the connection adapter information 660, and the unique device identification ID 670 by the “device registration process” described in detail below.

The row number 610 is the number of the rows of the locations list table TB2, and the numbers are assigned from “1” in order from the top. The individual name (name) given to the industrial device 120 is registered (stored) in the device name 620. The location name to which the industrial device 120 belongs is registered (stored) in the affiliation location 630. The identification information for identifying the industrial device 120 given to the device data by the industrial device 120 is stored in “the device identification information 640 given by the industrial device 120”. The Identification information unique to each industrial device 120 belonging to one location is stored in the device identification-in-location ID 650. In this example, that identification information is the device identification-in-location ID (for example, “DYYY”, “YYY” being numbers). It should be noted that the identification information unique to each industrial device 120 belonging to one location may also be referred to as “device identification information-in-location” for convenience. Adapter identification information for identifying the adapter 100d to which the industrial device 120 is connected is registered (stored) in the connection adapter information 660. It should be noted that in this example the adapter identification information is the name of the adapter 100d. The adapter identification information may be adapter identification ID (e.g., “IT Adapter X”, where X is a number), for example. Unique device identification information (in this example, the unique device identification ID) generated by combining the location identification information (in this example, the location ID) and the device identification information-in-location (in this example, the device identification-in-location ID) is registered (stored) in the unique device identification ID 670. This unique device identification information is identification information in order for the data collection server 200 to uniquely identify each of all the industrial devices 120 managed by the data collection server 200. The unique device identification information is unique identification information for each of all industrial devices 120 managed by the data collection server 200.

<Location Registration Process>

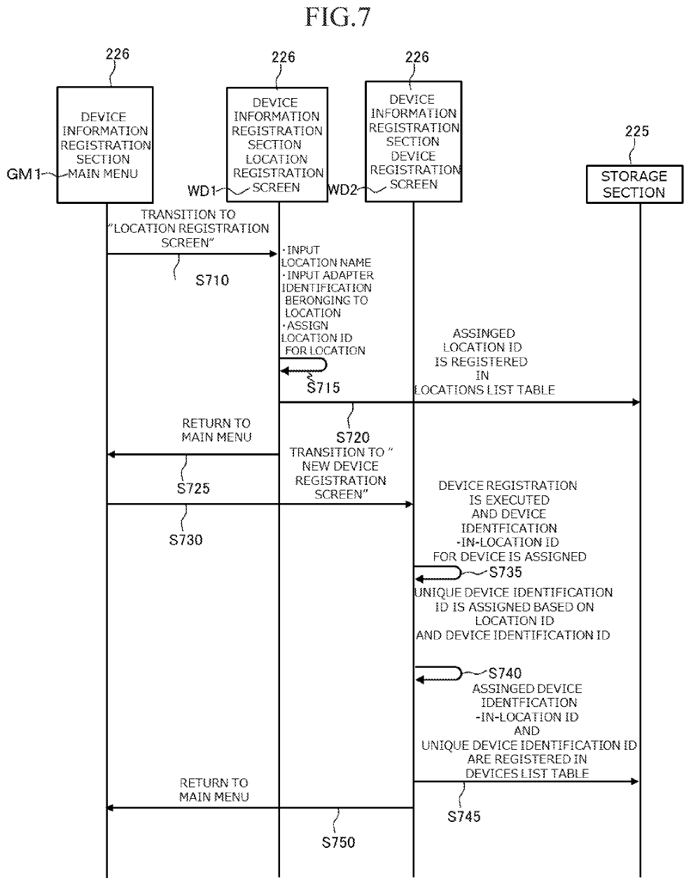

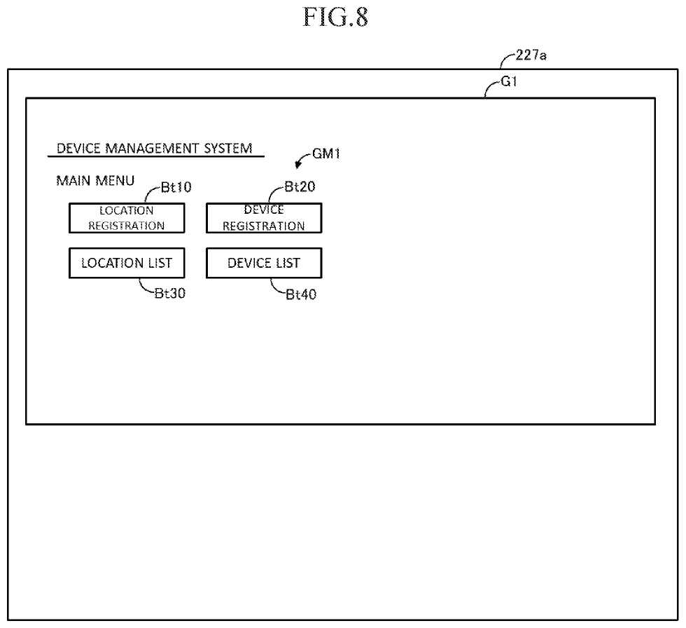

The following is a detailed description of the location registration process described above. The location registration process is executed by the device information registration section 226. FIG. 7 shows a sequence diagram to explain the process executed by the device information registration section 226. FIG. 8 shows a home screen G1 displayed on the display 227a of the terminal 227. The home screen G1 includes a main menu screen GM1 including various buttons such as a location registration button Bt10, a device registration button Bt20, a locations list button Bt30, and a devices list button Bt40.

The device information registration section 226 displays the home screen G1 on the display 227a of the terminal 227 in response to a request to display the home screen G1 based on user operation (the user operation of the terminal 227). The operation of the buttons on the home screen G1, entering/inputting text and other information into the input fields on the home screen G1, selecting choices, and the like are executed by the user operation.

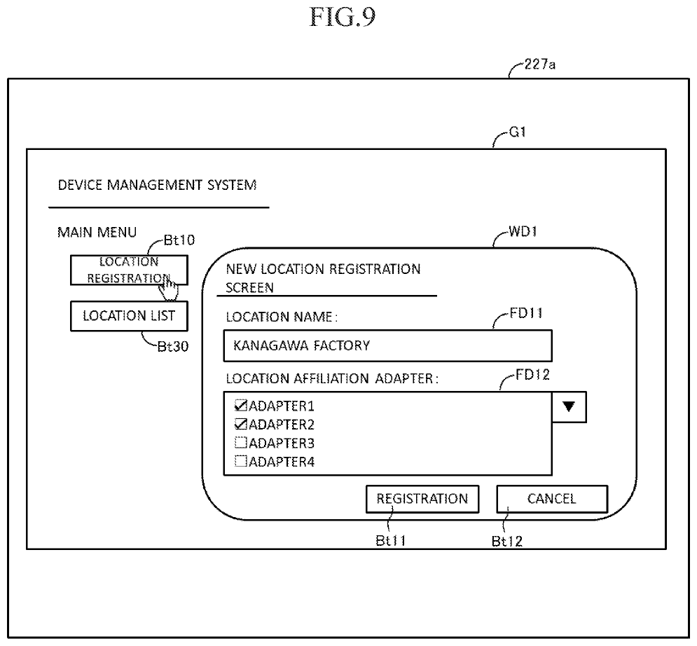

When the location registration button Bt10 in the home screen G1 is operated, the device information registration section 226 displays the location registration screen WD1 in the home screen G1 (refer to FIG. 7), as shown in FIG. 9.

The user enters the location name (for example, the location name to which the industrial device 120 that is about to execute the device registration described later belongs) and the adapter identification information of the adapter 100d belonging to the location. The location registration screen WD1 includes a location name input field FD11, a location affiliation adapter selection field FD12, a registration button Bt11, and a cancel button Bt12. The location affiliation adapter selection field FD12 includes a pull-down list of choices for the adapter identification information. It should be noted that the adapter identification information included in this pull-down list corresponds to multiple adapters 100d connected to the data collection server 200. That is, the adapter identification information for all the adapters 100d connected to the data collection server 200 are displayed as choices.

The location name of the location (the affiliation location) to which the industrial device 120 named by the user belongs is entered into the location name input column FD11 by the user operation (refer to S715 in FIG. 7). It should be noted that in the example shown in FIG. 9, the location name of the location to which the industrial device 120 to be newly registered belongs is “Kanagawa Factory”, so “Kanagawa Factory” is entered into the location input field FD11 by the user operation.

The check box to the left of the adapter identification information is selected by the user operation. Thereby, the adapter identification information of the adapter 100d belonging to the location of the location name entered in the location affiliation adapter selection field FD12 is entered into the location affiliation adapter selection field FD12 (refer to S715 in FIG. 7).

In a state where the location name (in an example shown in FIG. 9, “Kanagawa Plant”) has been entered in the location name input field FD11, and the adapter identification information has been entered in the location affiliation adapter selection field FD12, the registration button Bt11 is operated by the user operation. In the example shown in FIG. 9, “the adapter 1” and “the adapter 2” has been entered in the location affiliation adapter selection field FD12”.

Then, the device information registration section 226 assigns (generates) a location ID to the location name that has been entered in the location name input field FD11 at that time (refer to S715 in FIG. 7). The device information registration section 226 stores/registers the location name and the location ID assigned to the location name in the locations list table TB1 of the storage section 225 shown in FIG. 5 (refer to S720 in FIG. 7).

Specifically, the device information registration section 226 executes the process described below. The device information registration section 226 uses the “location name entered this time (to be registered in this process)” as a search key, and searches for location names that match the “location name” in the search key in the locations list table TB1.

When the location information registration section 226 is able to search for (identify) a location name that matches the “location name” of the search key, the location ID corresponding to the location name is already present. Therefore, the information registration section 226 does not execute the process of registering the location name and the location ID.

When the device information registration section 226 cannot find a location name that matches the “location name” of the search key, it assigns a new location ID corresponding to the location name. Specifically, the device information registration section 226 increases the number of the new location IDs of the last row of the information registered in the locations list table TB1 at this time by “1” to thereby assign/generate the new location ID.

The device information registration section 226 registers (stores) the row number, the location name, and the new location ID in the next row of the last row of the information currently registered in the locations list table TB1 (refer to S720 in FIG. 7). With the above, the location registration process is completed. At this time, the device information registration section 226 registers in the storage section 225 the registered location name and the adapter identification information that has been entered in the location affiliation adapter selection field FD12, in association with each other.

<Device Registration Process>

The device registration process described above is described in detail next. After the location registration process is completed, the device information registration section 226 ends the display of the location registration screen WD1 and displays only the home screen G1 on the display 227a again (refer to S725 in FIG. 7).

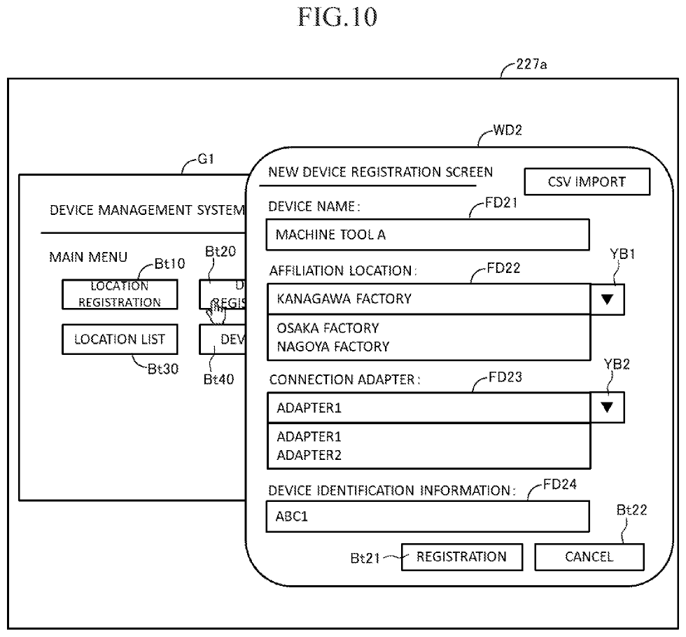

When the device registration button Bt20 in the home screen G1 is operated by the user operation, the device information registration section 226 displays the new device registration screen WD2 superimposed on part of the home screen G1 (refer to S730 in FIG. 7), as shown in FIG. 10. The new device registration screen WD2 includes a device name input field FD21, an affiliation location selection field FD22, a connection adapter selection field FD23, and a device identification information input field FD24.

The name of the industrial device 120 named by the user operation for the industrial device 120 to be newly registered is entered into the device name input field FD21 by the user operation.

The location name of the location to which the industrial device 120 to be newly registered belongs is entered into the affiliation location selection field FD22 by the user operation. Specifically, when the arrow button YB1 is operated by the user operation, one or more locations that have already been registered is displayed on the lower side of the affiliation location selection field FD22 as choices. One of the locations displayed as the choices is selected by the user operation, thereby, the selected location is entered into the affiliation location selection field FD22.

The adapter identification information of the adapter 100d connected to the industrial device 120 to be newly registered is entered into the connection adapter selection field FD23 by the user operation. Specifically, when the arrow button YB2 is operated by the user operation, the adapter identification information of one or more adapters 100d stored (registered) in the storage section 225 in association with the location entered in the affiliation location selection field FD22 is displayed on the lower side of the connection adapter selection field FD23 as choices. One of the adapter identification information as choices is selected by the user operation, thereby, the selected adapter identification information is entered into the connection adapter selection field FD23 as the adapter identification information of the adapter 100d to which the industrial device 120 to be newly registered is connected.

The device identification information to be assigned to the industrial device 120 to be newly registered is entered into the device identification information input field FD24 by the user operation. For example, the device identification information (e.g., the device identification information assigned at the time of product shipment) for identifying the industrial device 120 is entered into the device identification information input field FD24 by the user operation. It should be noted that this device identification information is required to be unique for each of all the industrial devices 120 that is connected to one adapter 100d via the PLC 110. Therefore, it is preferable that the following device identification information cannot be registered at this point. The device identification information is the device identification information that overlaps with the device identification information of the industrial device 120 connected to the adapter 100d corresponding to the adapter identification information entered in the connection adapter selection field FD23.

In a state where the device name, the location name, the adapter identification information, and the device identification information have been respectively entered in the device name input field FD21, the affiliation location selection field FD22, the connection adapter selection field FD23, and the device identification information input field FD24, the registration button Bt21 is operated by the user operation.

Then, the device information registration section 226 registers (stores) the information described later in the next row of the last row of the rows in which the information in the devices list table TB2 is registered at the present time.

The device information registration section 226 registers (stores) the device name entered in the device name input field FD21 in the device name 620 in the devices list table TB2. The device information registration section 226 registers (stores) the location name entered in the affiliation location selection field FD22 in the affiliation location 630 in the devices list table TB2. The device information registration section 226 registers (stores) the adapter identification information of the adapter 100d entered in the connection adapter selection field FD23 in the connection adapter information 660 in the devices list table TB2. The device information registration section 226 registers the device identification information entered in the device identification information input field FD24 in “the device identification information 640 given/assigned by the industrial device” in the devices list table TB2. The device information registration section 226 newly assigns (generates) the device identification-in-location ID (refer to S735 in FIG. 7). It should be noted that the device identification-in-location ID is identification information for uniquely identifying the industrial device 120 belonging to the same location as the location to which the industrial device 120 to be newly registered at this time belongs. The device information registration section 226 applies the location name to be newly registered to the locations list table TB1 to thereby acquire the location ID (the location identification information) corresponding to the location name. The device information registration section 226 combines the acquired location ID (the location identification information) and a new location device identification ID (location device identification information) to thereby assign/generate) a new unique device identification ID (the unique device identification information). That is, in this example, when the location ID is “F001” and the new device identification-in-location ID is “D0001”, the device information registration section 226 assigns/generates “F001-D0001”.

The device information registration section 226 registers the newly assigned/generated device identification-in-location ID and the unique device identification ID in the devices list table TB2 (refer to S745 in FIG. 7). With the above, the device registration process is completed. Thereafter, the device information registration section 226 ends the display of the new device registration screen WD2 and displays the home screen G1 again (refer to S750 in FIG. 7). As explained above, the device registration process and the location registration process described above are executed.

<Collection and Accumulation of Device-Related Data Sets>

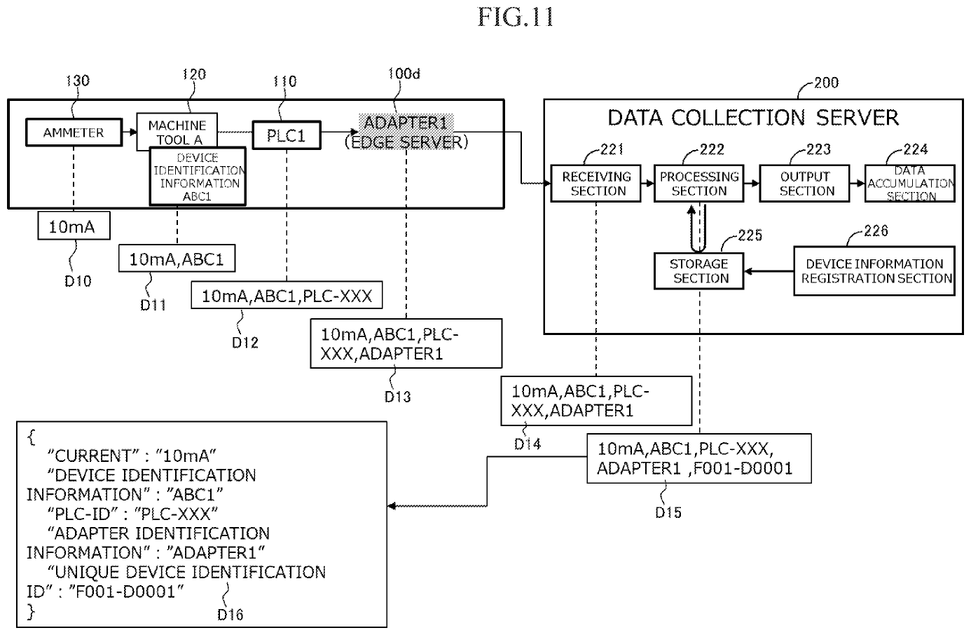

Next, the process of when the device management system collects and accumulates device-related data sets (hereinafter referred to as the “data collection and accumulation process”) will be described. FIG. 11 shows a figure for demonstrating the composition example of the data that the device management system collects when the sensor 130 is the ammeter, the industrial device 120 is a machine tool A, the device name of the machine tool A is a “machine tool A”, the PLC 110 is PLC1, the ID of the PLC1 is “PLC1”, the adapter 100d is the adapter 1, and the adapter identification information is the “adapter1”.

As shown in FIG. 11, the sensor 130 (the ammeter) acquires data D10 (10 mA) that is device data (current value) regarding the state of the industrial device 120 (the machine tool A) and outputs the acquired data D10 (10 mA) to the industrial device 120 (the machine tool A).

The industrial device 120 (the machine tool A) adds the device identification information (“ABC1”) of the industrial device 120 (the machine tool A) to the data D10 (10 mA) that have been received from the sensor 130 (the ammeter) and outputs the data D11 (“10 mA, ABC1”) to the PLC110 (PLC1).

The PLC 110 (PLC1) adds ID (“PLC-XXX”) of the PLC 110 (PLC1) to the data D11 (“10 mA, ABC1”) that have been received from the industrial device 120 (the machine toll A) and outputs the data D12 (10 mA, ABC1, PLC-XXX) to the adapter 100d (the adapter 1).

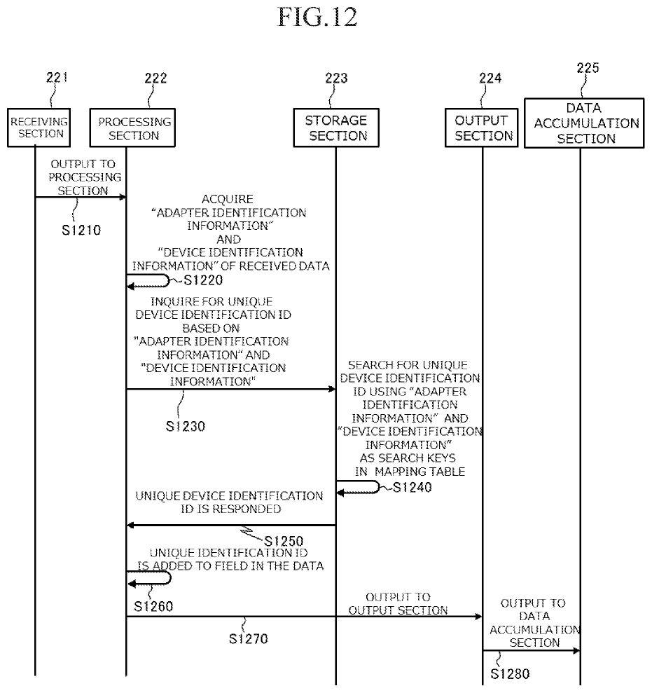

The adapter 100d (the adapter 1) adds the adapter identification information (“adapter1”) to the data D12 (“10 mA, ABC1, PLC-XXX”) that have been received from the PLC 110 (PLC1) and transfers the data D13 (“10 mA, ABC1, PLC-XXX, adapter 1”) to the data collection server 200. From here, the data collection accumulation process will be described with reference to FIG. 12 in addition to FIG. 11. FIG. 12 is a sequence diagram for explaining the processing after the time when the adapter 100d transfers the data D13 to the data collection server 200.

The receiving section 221 of the data collection server 200 outputs the data D14 (“10 mA, ABC1, PLC-XXX, adapter 1”) received from the adapter 100d (the adapter 1) to the processing section 222 (refer to S1210 in FIG. 12).

The processing section 222 acquires the “the adapter identification information (“adapter1”) and the device identification information (“ABC1”)” of the data D14 (refer to S1220 in FIG. 12). The processing section 222 instructs the storage section 225 to search for the unique device identification ID based on the “adapter identification information (“adapter1”) and the device identification information (“ABC1”)” (refer to S1230 in FIG. 12).

When the storage section 225 receives a search command from the processing section 222, the storage section 225 searches for the unique device identification information ID in the row that matches the search key (including both the search key “adapter identification information (“adapter1”)” and “device identification information (“ABC1”)”) (refer to S1240 in FIG. 12). When the storage section 225 is able to retrieve (identify) the unique device identification ID as a result of the search, the storage section 225 outputs (responds) the unique device identification ID to the processing section 222 (refer to S1250 in FIG. 12). As will be described in detail later, when the storage section 225 assigns/generates the unique device identification ID newly even if the storage section cannot search the unique device identification ID, the storage section 225 outputs (responds) the newly assigned/generated unique device identification ID to the processing unit 222. It should be noted that S1240 and S1250 executed by the storage section 225 will be described in more detail later.

The processing section 222 receives the unique device identification ID from the storage section 225 and adds the unique device identification ID (“F001-D0001”) to the data D14 (“10 mA, ABC1, PLC-XXX, adapter 1”). That is, the processing section 222 adds the unique device identification ID to the field of data D14 (refer to S1260 in FIG. 12). The processing unit 222 processes the data D15 (“10 mA, ABC1, PLC-XXX, adapter 1, F001-D0001”) from the CSV format to the JSON format data D16 and outputs the processed data D16 to the output section 223 (refer to S1270 in FIG. 12). The output section 223 outputs the processed data D16 received from the processing section 222 to the data accumulation section 224 (refer to S1280 in FIG. 12). The data accumulation section 224 stores/accumulates the processed data D16 received from the output unit 223. It should be noted that each of data D13 to D16 may also be referred to as “data set” for convenience.

<Details of the processes of S1240 and S1250 executed by the storage section 225>

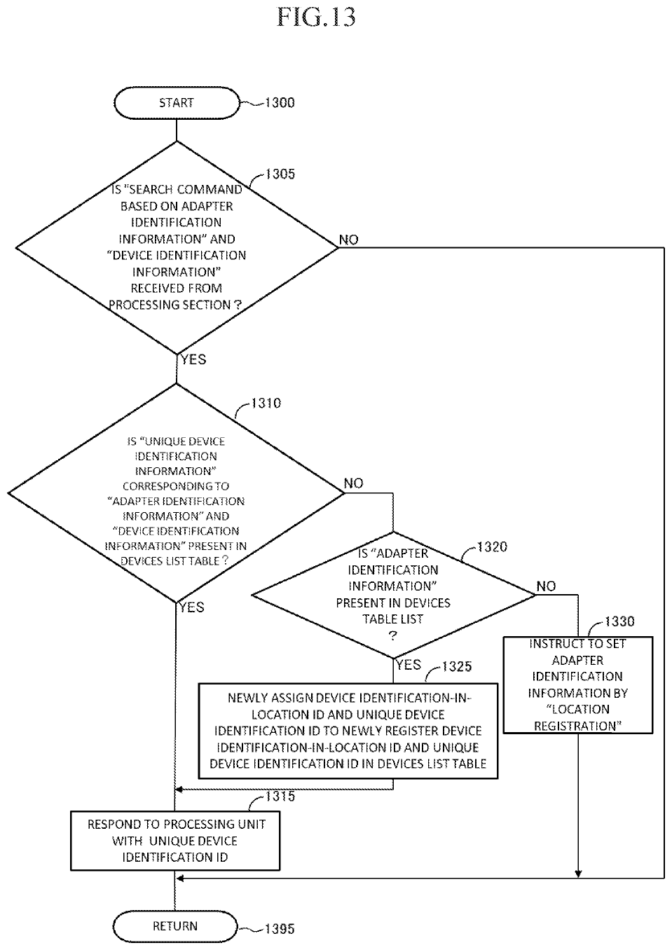

The processes of S1240 and S1250 in FIG. 12 executed by the storage section 225 will be described more specifically. The storage section 225 executes the routine shown by the flowchart in FIG. 13 every time a predetermined time elapses. Accordingly, the storage section 225 starts from step 1300 of FIG. 13 and proceeds to step 1305 to determine whether or not a “the search command based on the adapter identification information” and “the device identification information” are received from the processing section 222.

When the “search command based on the adapter identification information and the device identification information” are not received from the processing section 222, the storage section 225 makes a “No” determination at step 1305 and proceeds to step 1395 to tentatively terminate the present routine.

In contrast, when the “the search command based on the adapter identification information and the device identification information” are received from the processing section 222, the storage section 225 makes a “Yes” determination at step 1305 and proceeds to step 1310 to determine whether or not it is possible to search (specify) the unique device identification ID in the row that matches (including both) both “adapter identification information” and “device identification information” of the search key (the unique device identification ID is present) in the devices list table TB2.

When it is possible to search (specify) the unique device identification ID in the row that matches (including both) both “adapter identification information” and “device identification information” of the search key, the storage section 225 makes a “Yes” determination at step 1310 and proceeds to step 1315 to respond (output) the unique device identification ID to the processing section 222. Thereafter, the storage section 225 proceeds to step 1395 to tentatively terminate the present routine.

In contrast, when it is not possible to search (specify) the unique device identification ID in the row that matches (including both) both “adapter identification information” and “device identification information” of the search key, the storage section 225 makes a “No” determination at step 1310 and proceeds to step 1320 to determine whether or not it is possible to retrieve (identify) a row in the devices list table TB2 that matches only the “adapter identification information” of the search key.

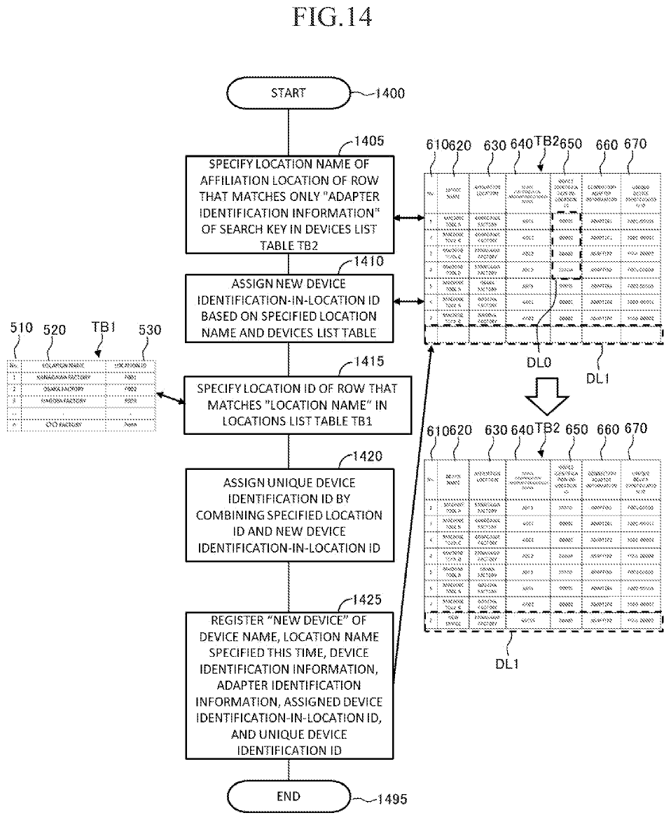

When it is possible to retrieve (identify) a row in the devices list table TB2 that matches only the “adapter identification information” of the search key, the storage section 225 makes a “Yes” determination at step 1320 and proceeds to step 1325 to newly assign a device identification-in-location ID and a unique device identification ID to newly register the device identification-in-location ID and the unique device identification ID in the devices list table TB2. Specifically, the storage section 225 executes the routine shown by the flowchart in FIG. 14 described below to newly assign the device identification-in-location ID and the unique device identification ID.

Thereafter, the storage section 225 registers the device identification-in-location ID, the unique device identification ID, and the like in the devices list table TB2.

Thereafter, the storage section 225 proceeds to step 1315 to output (respond) the unique device identification ID that has been newly assigned at step 1325 to the processing section 222. Thereafter, the storage section 225 proceeds to step 1395 to tentatively terminate the present routine.

It should be noted that when the row that matches only the “adapter identification information” of the search key cannot be searched/retrieved at the time of executing the process of step 1320, the “adapter identification information” is not registered in the devices list table TB2 at this time. In other words, there is a high possibility that the location registration process has not been executed for the adapter 100d corresponding to the “adapter identification information” at this point in time. Therefore, in this case, the storage section 225 sends a location registration recommendation instruction to the device information registration section 226 in order to encourage the user to register the adapter identification information by the location registration. It should be noted that for example, when the device information registration section 226 receives the location registration recommendation instruction, the device information registration section display an image that includes a message encouraging the location registration on the display 227a of the terminal 227 to thereby notify the user in order to urge the user to register a location. Thereafter, the storage section 225 proceeds to step 1395 to tentatively terminate the present routine.

The routine shown in FIG. 14 is described. The storage section 225 proceeds to step 1325 and starts the process from step 1400 to sequentially execute steps 1405 to step 1425 described below.

Step 1405: the storage section 225 specifies the location name of the affiliation location 630 of the row that matches (including) only the “adapter identification information” of the search key in the devices list table TB2.

Step 1410: the storage section 225 assigns a device identification-in-location ID for uniquely identifying the industrial device 120 belonging to the location of the location name specified at this time. Specifically, the storage section 225 increases “the device identification-in-location ID of the maximum value among all the device identification-in-location IDs (the device identification-in-location IDs surrounded by the dotted line DL0) for the same base as the newly registered base already registered in the devices list table TB2” by “1” and assigns the increased device identification-in-location ID as a new device identification-in-location ID.

Step 1415: the storage section 225 uses the location name specified at step 1405 in the locations list table TB1 as a search key and specifies the location ID of the row that matches (including) the “location name” of the search key.

Step 1420: the storage section 225 assigns a unique device identification ID by combining the location ID specified at step 1415 and the new device identification-in-location ID assigned/generated at step 1410.

Step 1425: the storage section 225 registers the information in each item (the device name 620, the affiliation location 630, the device identification information 640 assigned by the device, the device identification-in-location 650, the connection adapter information 660, and the unique device identification ID 670) in the next row (the row enclosed by the dotted line DL1 in FIG. 14) of the last row of the information currently registered in the devices list table TB2.

The storage section 225 registers a predetermined name (e.g., “New Device”) in the device name 620. The storage section 225 registers the location name (e.g., “KANAGWA PLANT”) specified at step 1405 in the affiliation location 630. The storage section 225 registers the “device identification information (e.g., “ABC15”)” of the search key in the device identification information 640 assigned by the industrial device 120. The storage section 225 registers the device identification-in-location ID (e.g., “D0005”) that has been newly assigned/generated at step 1410 in the device identification-in-location ID 650. The storage section 225 registers the “adapter identification information (e.g., “adapter2”) of the search key in the connection adapter information 660. The storage section 225 registers the unique device identification ID (e.g., “F001-D0005”) that has been newly assigned at step 1420 in the unique device identification ID 670.

Thereafter, the storage section 225 proceeds to step 1315 of FIG. 13 via step 1495.

As explained above, even when the row that matches both of the “adapter identification information” of the search key and the “device identification information” are not present in the devices list table TB2, when only the “adapter identification information” of the search key is present in the devices list table TB2, the location to which the industrial device 120 corresponding to the device-related data belongs is specified from the location name of the affiliation location 630 of a row including only the adapter identification information of the devices list table TB2 based on the adapter identification information. Furthermore, the location name is applied to the location list table TB1 and as a result, the location ID corresponding to the location name is specified. Furthermore, since the location names are known, all the device identification-in-location ID(s) that matches the location name in the devices list table TB2 is specified and the new device identification-in-location ID can be assigned based on all the specified device identification-in-location ID(s). That is, the number of the specified device identification-in-location IDs of the maximum value of the number of all the specified device identification-in-location IDs is increased by “1”, thereby, a new device identification-in-location ID can be newly assigned. Furthermore, a unique device identification ID can also be newly assigned/generated by combining the specified location ID and the new device identification-in-location ID.

Therefore, for example, even when the data collection server 200 receives a device-related data set including the device data of the industrial device 120 that the device registration has not been executed (that is, when the device-related data set including the device data of the industrial device 120 is received when the corresponding information in the row unit for the industrial device 120 in the device list table TB2 is not registered), the data collection sever 200 can assign/generate and give a unique device identification ID to the device-related data set.

That is, if the corresponding information in the row unit including the adapter identification information of the adapter 100d to which the industrial device 120 to which the device registration has not been executed is registered in the device list table TB2, the “adapter identification information” that matches the “adapter identification information” included in the device-related data set is already present in the devices list table TB2. The location name and all the device identification-in-location ID corresponding to the location name can be specified based on the matching “adapter identification information”. Furthermore, the location ID corresponding to the location to which the adapter 100d belongs can also be specified by referring to the locations list table TB1. Therefore, even if the data collection data server 200 receives the device-related data set including the device data of the industrial device 120 that the device registration is not executed, the data collection server 200 can newly assign/generate a unique device identification ID to that device-related data set.

Furthermore, thereafter again, when the data collection server 200 receives the device-related data set including the device data of that industrial 120, the corresponding information in a row unit including the adapter identification information of the adapter 100d is already registered in the devices list table TB2. Therefore, the data collection server 200 can assign the unique device identification ID of the corresponding information to the device-related data set.

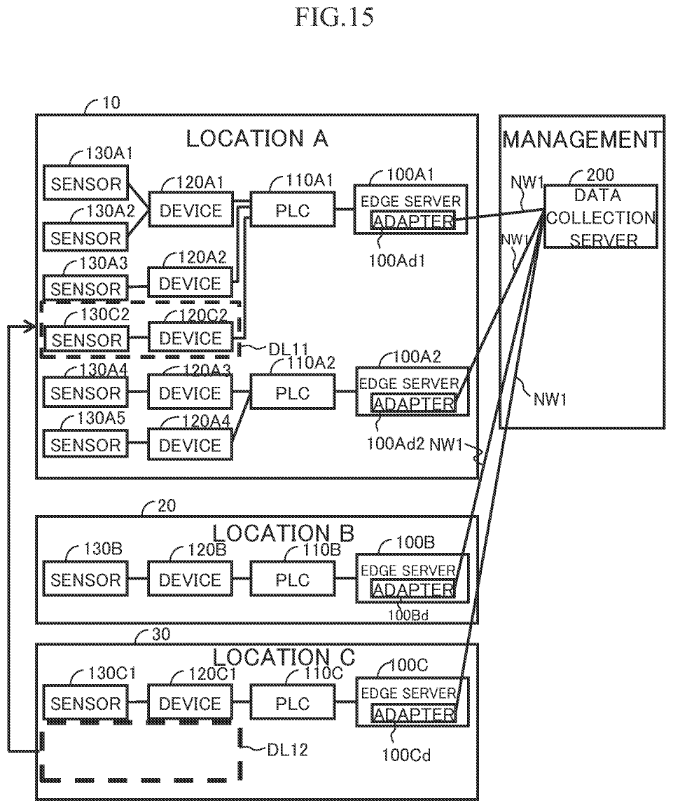

Therefore, for example, as shown in FIG. 15, in FIG. 1, suppose that the industrial device 120C2 that belongs to the location C 30 shown by a dotted line DL12 in FIG. 15 and has connected to the adapter 100C moves the location A 10 shown by the dotted line DL11 in FIG. 15 and belongs the location A 10 to connect the adapter 100Ad1 belonging to the location A 10.

In this case, if the corresponding information in the row unit that includes the adapter identification information of the adapter 100d connected to that industrial device 120 has been registered in the devices list table TB2, even when the user does not newly execute the device registration for that industrial device 120C2, the unique device identification information ID can be assigned to the device-related data set including the device data of the industrial device 120C2. That is, in this case, when the data collection server 200 receives the device-related data set including the device data from the industrial device 120C2, the data collection serves 200 can assign a new unique device identification ID and add it to the device-related data set including the device data of the industrial device 120C2. Thereafter, the data collection server 200 can add/give the unique device identification ID registered in the devices list table TB2 to the device-related data set including the device data of the industrial device 120C2.

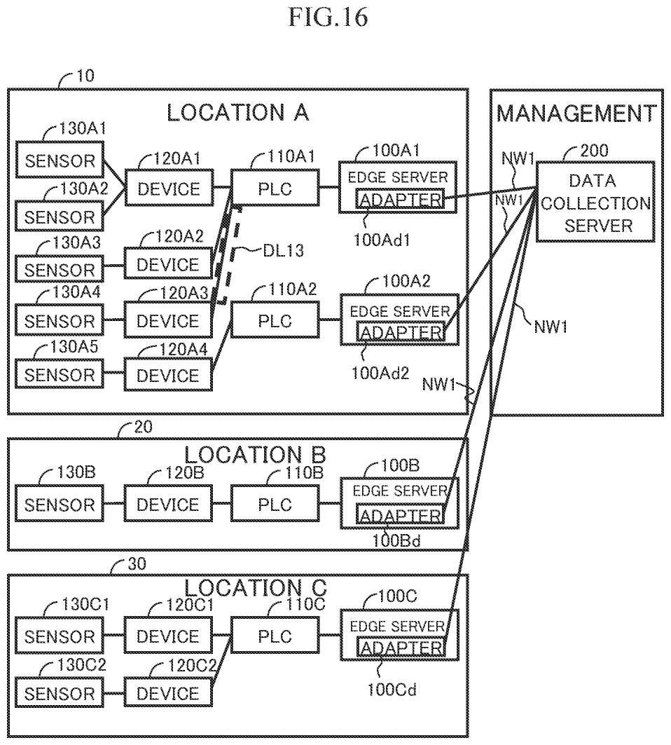

Furthermore, for example, as shown in FIG. 16, in FIG. 1, it is assumed that the industrial device 120A3 belonging to the location A 10 and connected to the adapter 110Ad2 belonging to the base A10 is replaced so as to be connected to the adapter 100Ad1 as shown by the dotted line DL13. Also in this case, similarly to the above, when the data collection server 200 receives the device-related data set including the device data from the industrial device 120A3, the data collection server 200 can assign/generate a new unique device identification ID to the device-related data set including the device data of the industrial device 120A3. Furthermore, thereafter, the data collection server 200 can add/give the unique device identification ID registered in the devices list table TB2 to the device-related data set including the device data of the industrial device 120A2.

Furthermore, for example, as shown by a dotted line DL14 and a dotted line DL15, in FIG. 1, suppose that the industrial device 120A3 connected to the adapter 100Ad2 is connected to the adapter 100Ad1, and the industrial device 120A2 connected to the adapter 100Ad1 is replaced so as to be connected to the adapter 100Ad2. Also in this case, similarly to the above, when the data collection server 200 receives the device-related data set including the device data from the industrial device 120A2, the data collection server 200 can assign/generate a new unique device identification ID to the device-related data set including the device data of the industrial device 120A2. Furthermore, thereafter, the data collection server 200 can add the unique device identification ID registered in the devices list table TB2 to the device-related data set including the device data of the industrial device 120A2. Furthermore, when the data collection server 200 receives the device-related data set including the device data from the industrial device 120A3, the data collection server 200 can generate/assign a new unique device identification ID to the device-related data set including the device data of the industrial device 120A3. Furthermore, thereafter, the data collection server 200 can add/give the unique device identification ID registered in the devices list table TB2 to the device-related data set including the device data of the industrial device 120A3.

Furthermore, in these cases, on the side of the data collection server 200, based on the unique device identification ID added to the device-related data set, by referring to the devices list table TB2, it is also possible to grasp which device data is information about the industrial device 120 connected to which adapter 100d at which location. Therefore, on the data collection server 200 side, it is also possible to quickly grasp that the industrial device 120 has been added, the industrial device 120 has been replaced, or the industrial device 120 has been replaced.

<Effect>

As explained above, according to the device management system according to the embodiment of the present disclosure, even when the location where the industrial device 120 is installed is changed, the user does not need to perform any particular work to change the unique device identification ID. Thereby, the device management system can reduce workload of the user. Furthermore, according to this device management system, even when the adapter 100d to which the industrial device 120 is connected is changed (when the industrial device 120 is connected to another adapter 100d), this device management system can reduce the workload of the user as above. Furthermore, in these cases, it becomes possible to grasp whether the device data of the industrial device 120 is the data related to the industrial device 120 connected to which adapter 100d at which location, based on the unique device identification ID.

### Modified Example

The present disclosure is not limited to the above embodiments, and various variations can be adopted within the scope of the disclosure. For example, in the above embodiment, the storage section 225 may include a location connection adapter list table TB3 (not shown). The location connection adapter list table TB3 includes a row number, an affiliation location, and one or more connection adapter information (adapter identification information). In this case, the location registration process registers the location name in the affiliation location of the location connection adapter list table TB3 and registers adapter identification information belonging to the location corresponding to the location name in the connection adapter information. Furthermore, in this case, the storage section 225 executes a routine different from that of FIG. 13 only when the following step 1327 is added between step 1320 and step 1330 of FIG. 13. The storage section 225 further executes a routine that differs only in that step 1405 in FIG. 14 is replaced with step 1405A described below.

Step 1327: the storage section 225 determines whether or not a row matching the “adapter identification information” of the search key can be retrieved (identified) in the location connection adapter list table TB3. When the row matching the “adapter identification information” of the search key cannot be retrieved (identified) in the location connection adapter list table TB3, the storage section 225 makes a “No” determination at step 1327 to proceed to step 1330. When the row matching the “adapter identification information” of the search key can be retrieved (identified) in the location connection adapter list table TB3, the storage section 225 makes a “Yes” determination at step 1327 to proceed to step 1325.

Step 1405A: the storage section 225 specifies, in the location connection adapter list table TB3, the location name of the affiliation location of the row matching (including) the “adapter identification information” of the search key.

Furthermore, in this case, the device registration process may be omitted. In this case, the location name is specified by referring to the location connection adapter list table TB3 when the data collection server 200 receives the device-related data set including the device data from the industrial device 120 only by the location registration process. By referring to the locations list table TB1 and the devices list table TB2 based on the location name, the new unique device identification ID is assigned to the device-related data set, and the corresponding information is registered in the devices list table TB2. Once the corresponding information is registered in the devices list table TB2, after that, when the data collection server 200 receives the device-related data set including the device data from the industrial device 120, the devices list table TB2 is referred. Thereby, the unique device identification ID can be assigned to the device-related data set.

What is claimed is:

1. A device management system comprising:
a management server including a data accumulation section capable of storing data; and
an edge server that communicates with the management server each other and that includes an adapter configured to acquire data from one or more devices belonging to one location,
wherein,
the edge server is configured to:
acquire device data that are data on the device and device identification information that the device associates with the device data; and
transfer, via the adapter that associates adapter identification information for identifying the adapter with the device data, a device-related data set including the device data, the device identification information, and
the adapter identification information that are associated with each other, to the management server;
the management server includes a storage section storing:
a plurality of pieces of first corresponding information in which a location name of the location to which the adapter belongs and location identification information for uniquely identifying the location are associated with each other; and
a plurality of pieces of second corresponding information in which the location name, the adapter identification information, the device identification information, device identification information-in-location for uniquely identifying the device belonging to the location within the location, and unique device identification information generated by combining the location identification information and the device identification information-in-location that are associated with each other; and
the management server is configured to:
upon receipt of the device-related data set,
combine, when the management server is unable to specify the second corresponding information that both of the adapter identification information and the device identification information of the received device-related data set matches, in the storage section and the management server is able to specify the second corresponding information that only the adapter identification matches, in the storage section, the location identification information of the first corresponding information corresponding to the location name of the specified second corresponding information and the device identification information-in-location newly generated to thereby generate a new unique device identification information;
associate the new unique device identification information with the received device-related data set; and
thereafter, store the device-related data set in the data accumulation section.

2. The device management system according to claim 1,
wherein,
the management system is configured to:
upon receipt of the device-related data set,
associate, when the management system is able to specify the second corresponding information that both of the adapter identification information of the received device-related data set and the device identification information match, in the storage section, the adapter information of the specified the second corresponding information with the received device-related data set; and
thereafter, store the device-related data set in the data accumulation section.

3. The device management system according to claim 2,
wherein,
the management server is configured to:
upon receipt of the device-related data set,
store, when the management server is unable to specify the second corresponding information that both of the adapter identification information of the received device-related data set and the device identification information match, in the storage section and the management server is able to specify the second corresponding information that only the adapter identification matches, in the storage section, the new second corresponding information in which the location name of the specified second corresponding information, the adapter identification information and the device identification information of the received device-related data set, the new device identification information-in-location, and the new unique device identification information are associated with each other, in the storage section.

4. The device management system according to claim 1,
wherein,
the management server connected to a terminal, the management server is configured to:
generate the new first corresponding information based on information that has been input into the terminal; and
store the generated new first corresponding information in the storage section.

5. The device management system according to claim 1,
wherein,
the management server connected to a terminal, the management server is configured to generate the new second corresponding information based on information that has been input into the terminal; and
store the new second corresponding information in the storage section.

6. The device management system according to claim 5,
wherein,
the management server is configured to:
upon receipt of the device-related data set,
execute, when the management server is unable to specify the second corresponding information in which both of the adapter identification information of the received device-related data set and the device identification information match, in the storage section, and the management server is unable to specify the second corresponding information that only the adapter identification information matches, in the storage section, notification to prompt a user to input the information necessary for generating the second corresponding information in which both the adapter identification information and the device identification information of the received device-related data set match.

7. The device management system according to claim 1,
wherein,
third corresponding information in which the location name and the adapter identification information are associated with each other is stored in the storage section; and
the management server is configured to:
upon receipt of the device-related data set,
combine, when the management server is unable to specify the second corresponding information in which both of the adapter identification information of the received device-related data set and the device identification information match, in the storage section, the management server is unable to specify the second corresponding information that only the adapter identification information matches, in the storage section, and the management server is able to specify the third corresponding information that the adapter identification information matches, in the storage section, the location identification information of the first corresponding information corresponding to the location name of the specified third corresponding information and the device identification information-in-location newly generated to thereby generate a new unique device identification information;
associate the new unique device identification information with the received device-related data set; and
store the device-related data set in the data accumulation section.

8. The device management system according to claim 7,
wherein,
the management server connected to a terminal in which the user can input information, the management server is configured to:
generate the new third corresponding information based on the information input to the terminal; and
store the new third corresponding information in the storage section.

9. A device management system comprising:
a management server including a data accumulation section capable of storing data; and
an edge server that communicates with the management server each other and that includes an adapter configured to acquire data from one or more devices belonging to one location,
wherein,
the edge server is configured to:
acquire device data that are data on the device and device identification information that the device associates with the device data; and
transfer, via the adapter that associates adapter identification information for identifying the adapter with the device data, a device-related data set including:
the device data;
the device identification information; and
the adapter identification information, these being associated with each other,
to the management server;
the management server includes a storage section storing:
location information of the location to which the adapter belongs and device identification information-in-location for uniquely identifying the device belonging to the location within the location, these being associated with the adapter identification information; and
unique device identification information generated based on location identification information and the device identification information-in-location and associated with both the adapter identification information and the device identification information,
the management server is configured to:
upon receipt of the device-related data set,
generate, when the unique device identification information associated with both the adapter identification information and the device identification information of the received device-related data set is not stored in the storage section, a new unique device identification information
based on:
the location identification information associated with the adapter identification information of the received data-related data set, the location identification information being stored in the storage section; and
the device identification information-in-location stored in the storage section;
associate the new unique device identification information with the receive device-related data set; and
thereafter, store the device data-related data set in the storage section.

10. The device management system according to claim 9,
wherein,
the management server is configured to:
upon receipt of the device-related data set,
associate, when the unique device identification information associated with both the adapter identification information and the device identification information of the received device-related data set is stored in the storage section, the unique device identification information with the received device-related data set; and
thereafter, store the device-related data set in the storage section.

11. A device management device configured to:
acquire device data that are data on a plurality of devices belonging to one location and device identification information that the device associates with the device data; and
receive data-related data set transferred from edge server including an adapter via the adapter that associate adapter identification information with the device data, the data-related data set including the device data, the device identification information, and the adapter identification information that are associated with each other,
wherein,
the management device includes:
a data accumulation section capable of storing data; and
a storage section storing:
a plurality of pieces of first corresponding information in which a location name of the location to which the adapter belongs and location identification information for uniquely identifying the location are associated with each other; and
a plurality of pieces of second corresponding information in which the location name, the adapter identification information, the device identification information, device identification information-in-location for uniquely identifying the device belonging to the location within the location, and unique device identification information generated by combining the location identification information and the device identification information-in-location that are associated with each other; and
the management device is configured to:
upon receipt of the device-related data set,
combine, when the management device is unable to specify the second corresponding information that both of the adapter identification information and the device identification information of the received device-related data set matches, in the storage section and the management device is able to specify the second corresponding information that only the adapter identification matches, in the storage section, the location identification information of the first corresponding information corresponding to the location name of the specified second corresponding information and the device identification information-in-location newly generated to thereby generate a new unique device identification information;
associate the new unique device identification information with the received device-related data set; and
thereafter, store the device-related data set in the data accumulation section.
